(19) United States
(12) Patent Application Publication
(10) Pub. No.: US 2025/0306279 A1
(43) Pub. Date: Oct. 2, 2025

(54) OFFSET SPLICE POINT IN A FIBER LASER SYSTEM

(71) Applicant: Lumentum Operations LLC, San Jose, CA (US)

(72) Inventors: Matthew KUTSURIS, Dublin, CA (US); Panit CHANTHARASUPAWONG, Milpitas, CA (US); Guan SUN, San Jose, CA (US)

(21) Appl. No.: 18/650,951

(22) Filed: Apr. 30, 2024

Related U.S. Application Data
(60) Provisional application No. 63/571,254, filed on Mar. 28, 2024.

(51) Int. Cl. G02B 6/255; H01S 3/067

(52) U.S. Cl. CPC G02B 6/255; H01S 3/06708; H01S 3/06754

(57) ABSTRACT

A fiber laser system includes a first optical fiber that includes a first core with a first diameter and a second optical fiber that includes a second core with a second diameter that is greater than the first diameter. An end of the first optical fiber is connected to an end of the second optical fiber at a splice point. A center axis of the first core is not aligned with a center axis of the second core at the splice point. An offset distance at the splice point between the center axis of the first core and the center axis of the second core is greater than 2 micrometers. A stimulated Raman scattering (SRS) content of an output of the fiber laser system is less than or equal to 1%.

### CROSS-REFERENCE TO RELATED APPLICATION

This patent application claims priority to U.S. Patent Application No. 63/571,254, filed on Mar. 28, 2024, and entitled “OFFSET FIBER CORES OF A HIGH-POWER FIBER LASER.” The disclosure of the prior application is considered part of and is incorporated by reference into this patent application.

### TECHNICAL FIELD

The present disclosure relates generally to a fiber laser system and to an offset splice point in a fiber laser system.

### BACKGROUND

A high-power fiber laser is a fiber laser capable of delivering a relatively high output power. For example, the output power of a high-power fiber laser may be at least one kilowatt.

### SUMMARY

In some implementations, a fiber laser system includes a first optical fiber that includes a first core with a first diameter; and a second optical fiber that includes a second core with a second diameter that is greater than the first diameter, wherein: an end of the first optical fiber is connected to an end of the second optical fiber at a splice point, a center axis of the first core is not aligned with a center axis of the second core at the splice point, and an offset distance at the splice point between the center axis of the first core and the center axis of the second core is greater than 2 micrometers.

In some implementations, a fiber laser system includes a first optical fiber that includes a first core with a first diameter; and a second optical fiber that includes a second core with a second diameter, wherein: an end of the first optical fiber is connected to an end of the second optical fiber at a splice point, and an offset distance at the splice point between a center axis of the first core and a center axis of the second core is greater than 2 micrometers.

In some implementations, a fiber laser system includes a first optical fiber; and a second optical fiber, wherein: an end of the first optical fiber is connected to an end of the second optical fiber at a splice point, and an offset distance at the splice point between a first core of the first optical fiber and a second core of the second optical fiber allows a stimulated Raman scattering (SRS) content of an output of the fiber laser system to less than or equal to 1%.

### BRIEF DESCRIPTION OF THE DRAWINGS

FIGS. 1A-1C show example implementations of a fiber laser system.

FIGS. 2A-2B show example implementations of the fiber laser system described herein.

FIG. 3 shows an example plot for similarly configured fiber laser systems.

FIG. 4A shows example plots for similarly configured fiber laser systems.

FIG. 4B shows an example table that indicates data associated with the similarly configured fiber laser systems described above in relation to FIG. 4A.

### DETAILED DESCRIPTION

The following detailed description of example implementations refers to the accompanying drawings. The same reference numbers in different drawings may identify the same or similar elements.

A high-power fiber laser (e.g., kilowatt (KW) class, or higher, fiber laser) can be used in a material processing application, such as cutting, welding, engraving, marking, and/or another material processing application. It is often desirable for an output (e.g., that includes laser light) of the high-power fiber laser to have high brightness so as to enable faster cutting speed and better cut quality of a material (e.g., a metal or another hard material). One main limitation to scaling up brightness of the output is an increase in stimulated Raman scattering (SRS), which is a non-linear optical effect that converts signal light to a longer wavelength, within the output. A high SRS content (e.g., measured as a percentage (%)) results in an unstable output, loss of efficiency, increased heating, and degradation of beam parameter product (BPP).

In some cases, SRS gain can be mitigated by increasing a linewidth of a fiber laser, such as by using a Bragg spectrum and by increasing a fiber core size. However, this can result in BPP degradation and reduction in spectral density. Further, a fiber laser can be configured to have multiple peak wavelengths in an output coupler (OC) grating reflectivity spectrum, which increases a power threshold above which SRS levels begin to impact an output. This configuration requires, however, a complex fiber Bragg grating design and precise positioning of reflective components, which is difficult and time intensive to design, manufacture, and maintain. Moreover, an SRS filter (e.g., comprising tilted fiber Bragg gratings) can be used to increase a power threshold at which SRS levels begin to impact an output, but this requires an additional component in the fiber laser, resulting in more complexity and optical loss (e.g., due to an additional splice needed to include the SRS filter).

Some implementations described herein include a fiber laser system. The fiber laser system may be configured to enable kilowatt-class material processing. In some implementations, the fiber laser system comprises a first optical fiber that includes a first core and a second optical fiber that includes a second core. The first core has a first diameter that is less than a second diameter of the second core. An end of the first optical fiber is connected to an end of a second optical fiber at a splice point to allow laser light to propagate from the first optical fiber to the second optical fiber (e.g., from the first core to the second core).

At the splice point, a center axis of the first core is not aligned with a center axis of the second core. That is, a center point of a cross-sectional area of the first core does not contact a center point of a cross-sectional area of the second core at the splice point. This can be referred to as an offset splice. Accordingly, there is an offset distance (e.g., a non-zero offset distance) between the center axis of the first core and the center axis of the second core. The offset distance (e.g., at the splice point) satisfies (e.g., is greater than or equal to) an offset threshold, which reduces a peak intensity of the laser light within the second core and thus minimizes SRS gain along a length of the second optical fiber. In this way, the fiber laser system enables minimization (and, in some implementations, elimination) of an SRS content in an output (e.g., that includes the laser light) of the fiber laser system. For example, the offset distance causes the SRS content of the output to be less than or equal to a maximum allowable SRS content (e.g., that is associated with an optimal performance of the fiber laser system), such as 1% of the output.

Additionally, in some implementations, an entirety of the cross-sectional area of the first core contacts a portion of the cross-sectional area of the second core at the splice point. This allows the laser light to efficiently propagate from the first core to the second core and therefore a BPP and a spectral density of the output is the same as, or similar to, an output of a fiber laser that has optical fibers with aligned cores. Further, the offset splice point redistributes energy of the laser light to other modes, which makes the modes incoherent, and therefore a lower transverse mode instability (TMI) is generated in the output of the fiber laser system, which improves a quality of the output.

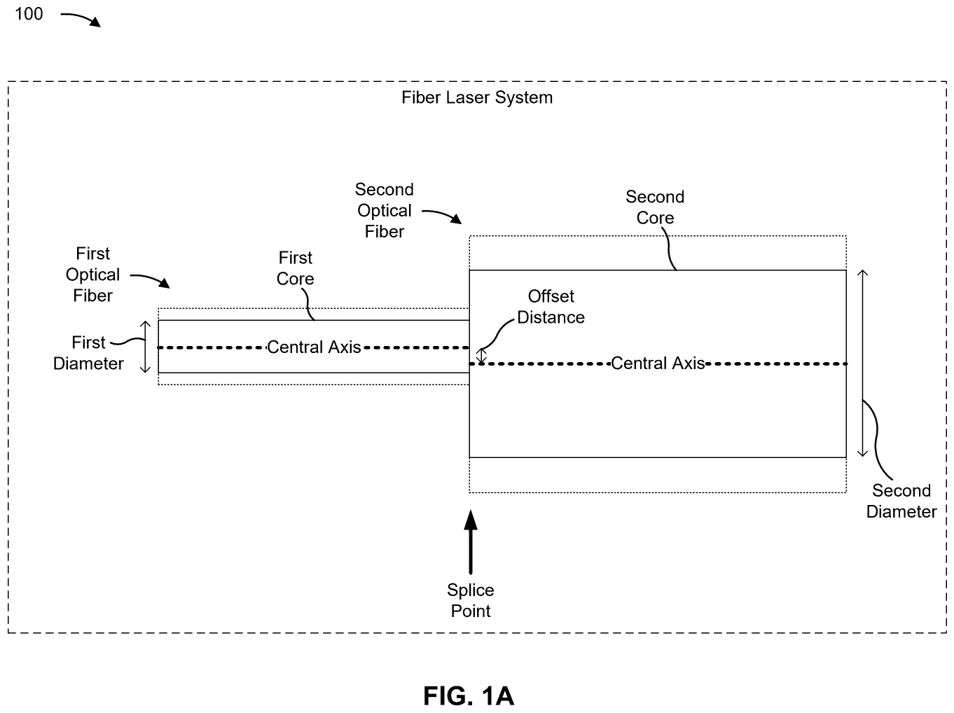

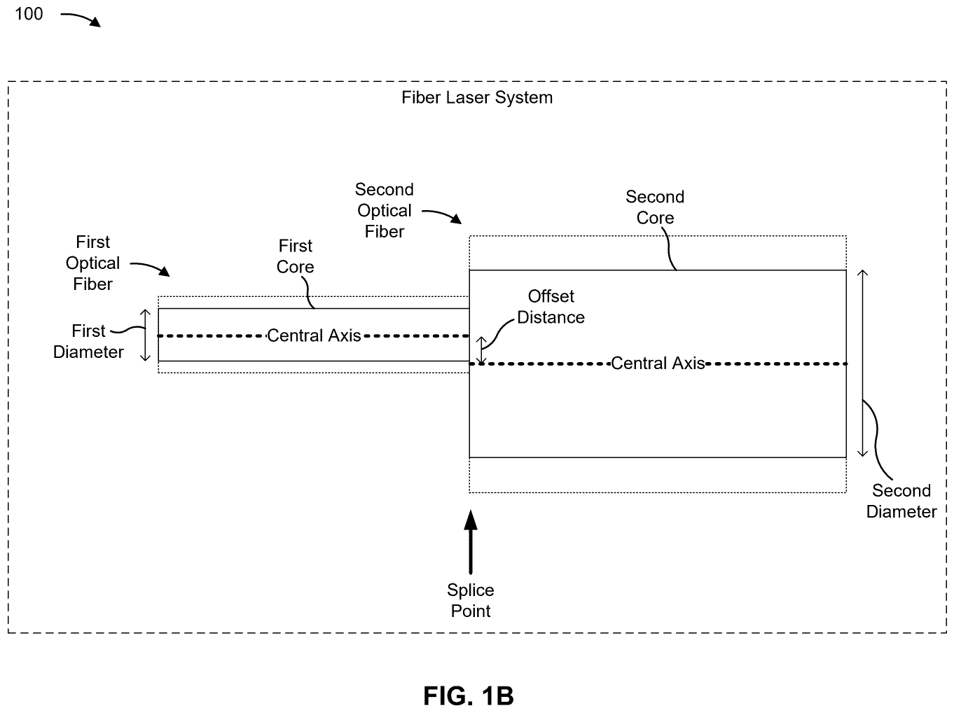

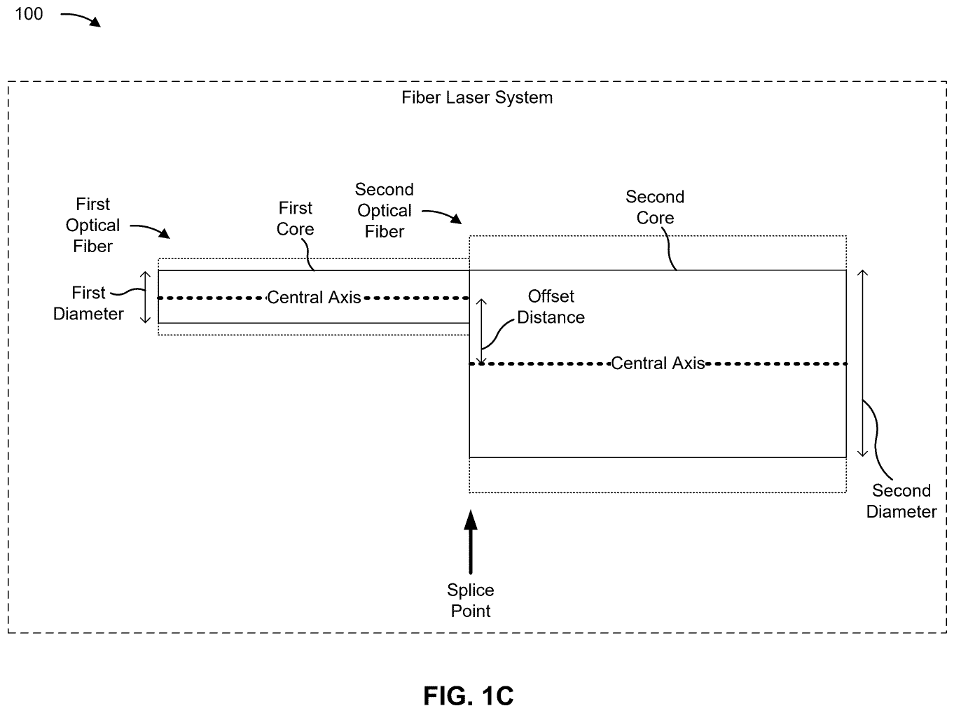

FIGS. 1A-1C show example implementations 100 of a fiber laser system. As shown in FIGS. 1A-1C, the fiber laser system may include a first optical fiber and a second optical fiber. FIG. 1A shows a first example configuration of the fiber laser system, FIG. 1B shows a second example configuration of the fiber laser system, and FIG. 1C shows a third example configuration of the fiber laser system.

The fiber laser system may be configured to propagate laser light, such as a high-power laser light, that is to be used in a material processing application, such as cutting, welding, engraving, marking, and/or another material processing application. For example, the fiber laser system may be configured to enable kilowatt-class material processing. In some implementations, the fiber laser system may be a master oscillator power amplifier (MOPA), the first optical fiber may be an oscillator optical fiber, and the second optical fiber may be an amplifier optical fiber.

As shown in FIGS. 1A-1C, the first optical fiber may include a first core, and, optionally, may include a first cladding and/or a first fiber jacket. The first core may comprise glass and/or another suitable material configured to transmit laser light (e.g., from an input end of the first core, shown as a left side of the first core, to an output end of the first core, shown as a right side of the first core). The first cladding may surround (e.g., circumferentially surround) the first core and be configured to confine the laser light (e.g., within the first core). The first fiber jacket may surround (e.g., circumferentially surround) the first core and/or the first cladding, and may comprise a material (e.g., a plastic material, such as polyethylene) that is configured to protect and/or shield the first core and/or the first cladding.

As further shown in FIGS. 1A-1C, the first core may have a first diameter. The first diameter may be a measure of a thickness of the first core at a splice point, further described herein. That is, the first diameter may be a measure of a thickness of a cross-sectional area of the first core at the splice point. Additionally, the first core may have a central axis. The central axis may run along a length of the first core (e.g., in a direction that is parallel to a propagation direction of laser light within the first core) and through a “center” point of the cross-sectional area of the first core at the splice point.

Additionally, as shown in FIGS. 1A-1C, the second optical fiber may include a second core, and, optionally, may include a second cladding and/or a second fiber jacket. The second core may comprise glass and/or another suitable material configured to transmit laser light (e.g., from an input end of the second core, shown as a left side of the second core, to an output end of the second core, shown as a right side of the second core). The second cladding may surround (e.g., circumferentially surround) the second core and be configured to confine the laser light (e.g., within the second core). The second fiber jacket may surround (e.g., circumferentially surround) the second core and/or the second cladding and may comprise a material (e.g., a plastic material, such as polyethylene) that is configured to protect and/or shield the second core and/or the second cladding.

As further shown in FIGS. 1A-1C, the second core may have a second diameter. The second diameter may be a measure of a thickness of the second core at the splice point, further described herein. That is, the second diameter may be a measure of a thickness of a cross-sectional area of the second core at the splice point. Additionally, the second core may have a central axis. The central axis may run along a length of the second core (e.g., in a direction that is parallel to a propagation direction of laser light within the second core) and through a center point of the cross-sectional area of the second core at the splice point.

In some implementations, the second diameter may be greater than the first diameter. In this way, the second core may be thicker than the first core (e.g., at the splice point). In some implementations, the second diameter is greater than or equal to at least X times the first diameter (e.g., at the splice point), where X>1. For example, the second diameter may be greater than or equal to three times the first diameter (e.g., at the splice point).

The first core and the second core may have other different characteristics as well. For example, the first core may a single-mode core or a reduced-mode core, and the second core may be a multi-mode core. That is, the second core may be configured to support more modes than the first core is configured to support. Put another way, the second core may be configured to support M modes, and the first core may be configured to support N modes, where M>N.

As further shown in FIGS. 1A-1C, an end of the first optical fiber (e.g., shown as a right end of the first optical fiber) is connected to an end of the second optical fiber (e.g., shown as a left end of the first optical fiber) at the splice point. That is, the first optical fiber may be fused to the second optical fiber at the splice point, such as to facilitate efficient transmission of laser light (e.g., with minimal loss or disruption) between the first optical fiber and the second optical fiber. In some implementations, the fiber laser system may be configured to allow laser light to propagate from the first optical fiber (e.g., from the first core of the first optical fiber) to the second optical fiber (e.g., to the second core of the second optical fiber) at the splice point. That is, the fiber laser system may be configured to allow laser light to propagate from the “thinner” first core to the “thicker” second core at the splice point.

Notably, at the splice point, the center axis of the first core is not aligned with the center axis of the second core. That is, the center point of the cross-sectional area of the first core does not contact the center point of the cross-sectional area of the second core at the splice point. For example, as shown in FIGS. 1A-1C, there may be an offset distance (e.g., a non-zero offset distance) between the center axis of the first core and the center axis of the second core. The offset distance may be in a particular dimension, such as in a vertical dimension shown in FIGS. 1A-1C.

FIG. 1A shows the first example configuration of the fiber laser system, where the offset distance is such that an entirety of the cross-sectional area of the first core contacts a portion of the cross-sectional area of the second core at the splice point, and where the portion of the cross-sectional area of the second core includes a point (e.g., the center point) associated with the center axis of the second core. FIG. 1B shows the second example configuration of the fiber laser system, where the offset distance is such that an entirety of the cross-sectional area of the first core contacts a portion of the cross-sectional area of the second core at the splice point, and where the portion of the cross-sectional area of the second core does not include a point (e.g., the center point) associated with the center axis of the second core. FIG. 1C shows the third example configuration of the fiber laser system, where the offset distance is such that an entirety of the cross-sectional area of the first core contacts a portion of the cross-sectional area of the second core at the splice point, where the portion of the cross-sectional area of the second core does not include a point (e.g., the center point) associated with the center axis of the second core, and where an edge of the first core is aligned with (and contacts) an edge of the second core.

In some implementations, the offset distance (e.g., at the splice point) may satisfy (e.g., may be greater than or equal to) an offset threshold. The offset threshold may be associated with, for example, a misalignment maximum associated with splicing the first optical fiber and the second optical fiber together at the splice point. That is, the offset threshold may be greater than a maximum cumulative sum of potential misalignment offsets that may occur as a result of splicing the first optical fiber and the second optical fiber together at the splice point. Accordingly, the offset threshold may be, for example, 1 micrometer (μm) (e.g., when the misalignment maximum is less than 1 μm), 2 μm (e.g., when the misalignment maximum is less than 2 μm), or 3 μm (e.g., when the misalignment maximum is less than 3 μm), among other examples. Additionally, or alternatively, the offset threshold may be, for example, 1% of the first diameter (e.g., when the misalignment maximum is less than 1% of the first diameter), 5% of the first diameter (e.g., when the misalignment maximum is less than 5% of the first diameter), or 10% of the first diameter (e.g., when the misalignment maximum is less than 10% of the first diameter), among other examples.

In some implementations, the offset distance may be designed to minimize an SRS content (e.g., that includes Stokes shifted SRS content and/or anti-Stokes shifted SRS content) of an output (e.g., that includes laser light that propagated from the first core to the second core at the splice point) of the fiber laser system. For example, the offset threshold may be associated with a maximum allowable SRS content of the output. That is, when the offset distance satisfies the offset threshold, the SRS content of the output is less than or equal to the maximum allowable SRS content of the output. Accordingly, the offset distance may cause the SRS content of the output to be less than or equal to the maximum allowable SRS content of the output. The maximum allowable SRS content of the output may be, for example, 1%, 2%, 3%, or another percentage, of the output that is associated with an optimal performance of the fiber laser system.

As indicated above, FIGS. 1A-1C are provided as an example. Other examples may differ from what is described with regard to FIGS. 1A-1C.

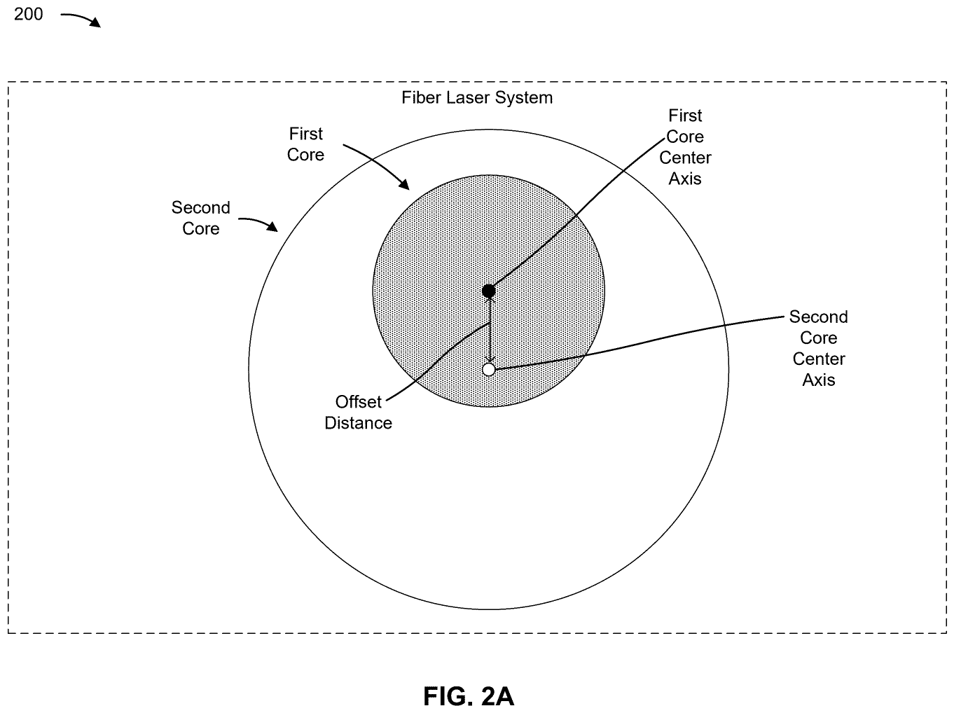

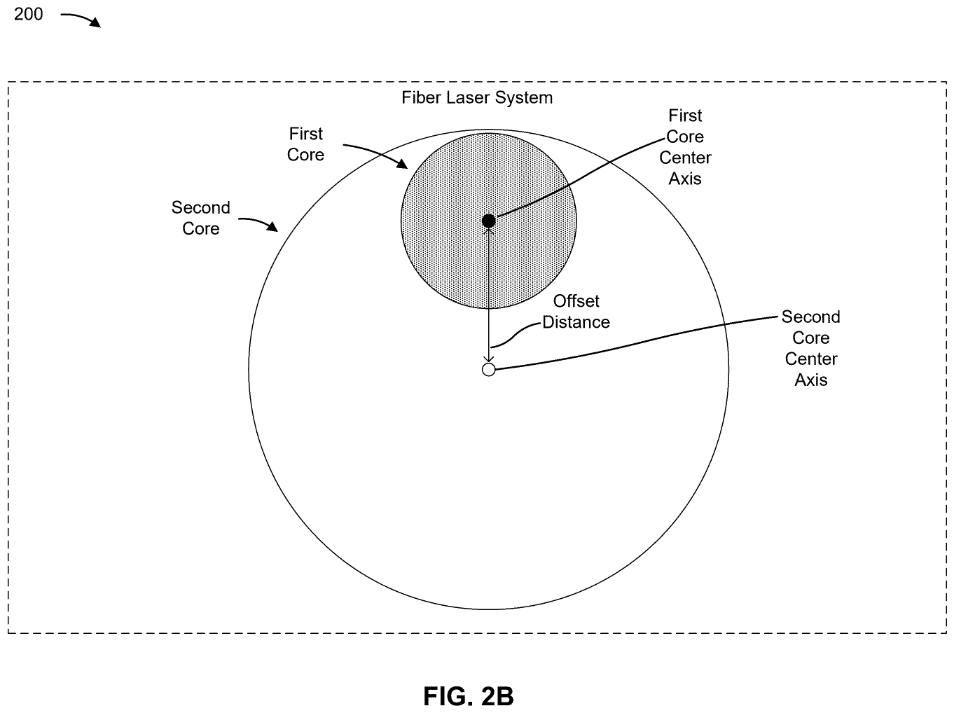

FIGS. 2A-2B show example implementations 200 of the fiber laser system described herein. FIG. 2A shows a first example configuration of how the cross-sectional area of the first core contacts a portion of the cross-sectional area of the second core at the splice point, and FIG. 2B shows a second example configuration of how the cross-sectional area of the first core contacts a portion of the cross-sectional area of the second core at the splice point.

As shown in FIG. 2A, the center axis of the first core is not aligned with the center axis of the second core at the splice point. That is, the center point of the cross-sectional area of the first core does not contact the center point of the cross-sectional area of the second core at the splice point and there is an offset distance (e.g., a non-zero offset distance) between the center axis of the first core and the center axis of the second core. The offset distance may be in a particular dimension, such as in a vertical dimension shown in FIG. 2A. Additionally, the offset distance is such that an entirety of the cross-sectional area of the first core contacts a portion of the cross-sectional area of the second core at the splice point, where the portion of the cross-sectional area of the second core includes a point (e.g., the center point) associated with the center axis of the second core.

As shown in FIG. 2B, the center axis of the first core is not aligned with the center axis of the second core at the splice point. That is, the center point of the cross-sectional area of the first core does not contact the center point of the cross-sectional area of the second core at the splice point, and there is an offset distance (e.g., a non-zero offset distance) between the center axis of the first core and the center axis of the second core. The offset distance may be in a particular dimension, such as in a vertical dimension shown in FIG. 2B. Additionally, the offset distance is such that an entirety of the cross-sectional area of the first core contacts a portion of the cross-sectional area of the second core at the splice point, where the portion of the cross-sectional area of the second core does not include a point (e.g., the center point) associated with the center axis of the second core.

As indicated above, FIGS. 2A-2B are provided as an example. Other examples may differ from what is described with regard to FIGS. 2A-2B.

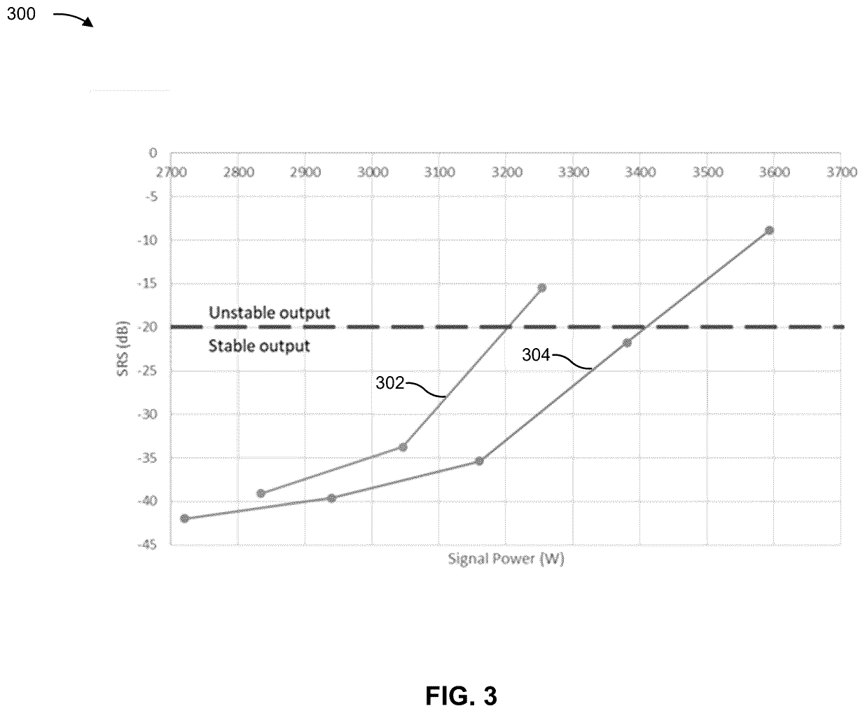

FIG. 3 shows an example plot 300. The example plot indicates an SRS content in similarly configured fiber laser systems (e.g., MOPA fiber laser systems). A first fiber laser system includes an oscillator output fiber core (e.g., as a first core) and an amplifier input fiber core (e.g., as a second core) with respective center axes that are aligned (e.g., an offset distance between the respective center axes is zero (0), or nearly zero, such as within a tolerance). The first fiber laser system's SRS content (measured in decibels (dB)) relative to signal power (measured in watts (W)) is indicated by line 302. A second fiber laser system includes an oscillator output fiber core (e.g., as a first core) and an amplifier input fiber core (e.g., as a second core) with respective center axes that are not aligned (e.g., there is an offset distance, as elsewhere described herein, between the respective center axes). The second fiber laser system's SRS content (measured in dB) relative to signal power (measured in W) is indicated by line 304.

Accordingly, example plot 300 shows that the second fiber laser system provides a stable output (indicated by a horizontal dashed line associated with an SRS of −20 dB) for higher signal powers than the first fiber laser system. For example, the second fiber laser system provides a stable output for signal powers up to at least 3375 W, while the first fiber laser system only provides a stable output for signal powers up to a maximum of 3200 W.

As indicated above, FIG. 3 is provided as an example. Other examples may differ from what is described with regard to FIG. 3.

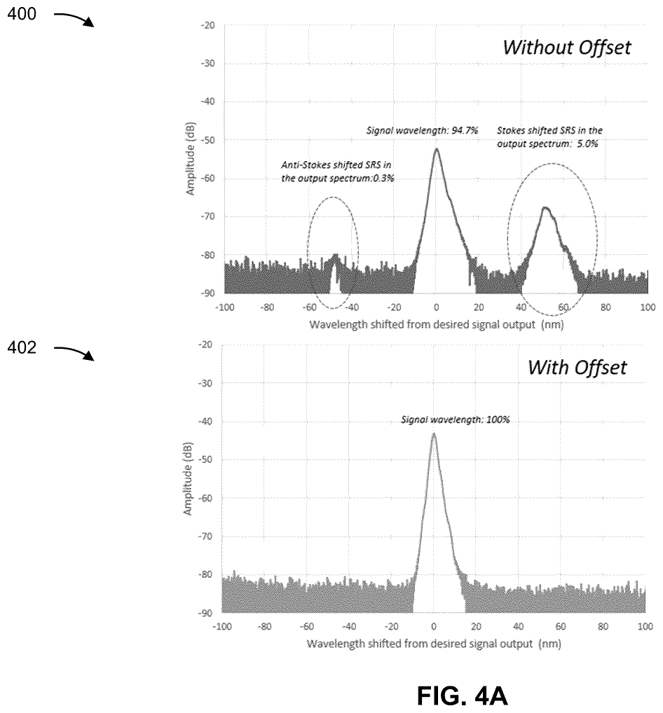

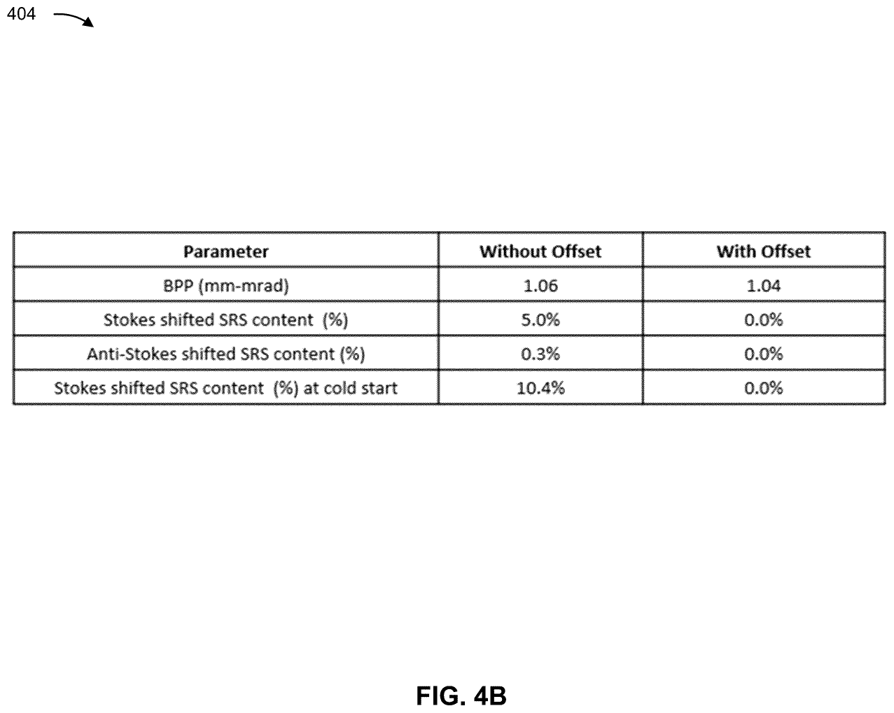

FIG. 4A shows example plots 400 and 402 for similarly configured fiber laser systems (e.g., MOPA fiber laser systems). Example plot 400 indicates a wavelength shift from a desired signal output (e.g., a desired wavelength, in nanometers (nm)) for a first fiber laser system that includes an oscillator output fiber core (e.g., as a first core) and an amplifier input fiber core (e.g., as a second core) with respective center axes that are aligned (e.g., an offset distance between the respective center axes is zero (0), or nearly zero, such as within a tolerance). Example plot 402 indicates a wavelength shift from a desired signal output (e.g., a desired wavelength, in nm) for a second fiber laser system that includes an oscillator output fiber core (e.g., as a first core) and an amplifier input fiber core (e.g., as a second core) with respective center axes that are not aligned (e.g., there is an offset distance, as elsewhere described herein, between the respective center axes). As shown in FIG. 4A, the first fiber laser system is subject to 5.0% Stokes shifted SRS content in the output spectrum and to 0.3% anti-Stokes shifted SRS content in the output spectrum, and thus only 94.7% of the output spectrum is associated with the desired signal output. As shown in FIG. 4B, the second fiber laser system is not subject to Stokes shifted SRS content and anti-Stokes shifted SRS content (or any SRS content is so minimal as to not be detectable at the resolution shown in example plot 402), so that 100% of the output spectrum is associated with the desired signal output.

FIG. 4B shows an example table 404 that indicates data associated with the first fiber laser system and the second fiber laser system (e.g., described above in relation to FIG. 4A). For example, the table 404 indicates that the second fiber laser system provides a similar BPP (e.g., measured in millimeters times milliradians (mm-mrad)) as the first fiber laser system and an improved performance in relation to Stokes shifted SRS content and anti-Stokes shifted SRS content (e.g., measured in percentage), including at a cold start, as compared to the first fiber laser system. Notably, the data is associated with each fiber laser system being configured with a 1079 nm wavelength using 6.5 kW of power, with spectra associated with the fiber laser systems being collected with data sampling at 2 kilohertz (kHz) modulation.

As indicated above, FIGS. 4A-4B are provided as an example. Other examples may differ from what is described with regard to FIGS. 4A-4B.

The foregoing disclosure provides illustration and description, but is not intended to be exhaustive or to limit the implementations to the precise forms disclosed. Modifications and variations may be made in light of the above disclosure or may be acquired from practice of the implementations. Furthermore, any of the implementations described herein may be combined unless the foregoing disclosure expressly provides a reason that one or more implementations may not be combined.

As used herein, satisfying a threshold may, depending on the context, refer to a value being greater than the threshold, greater than or equal to the threshold, less than the threshold, less than or equal to the threshold, equal to the threshold, not equal to the threshold, or the like.

Even though particular combinations of features are recited in the claims and/or disclosed in the specification, these combinations are not intended to limit the disclosure of various implementations. In fact, many of these features may be combined in ways not specifically recited in the claims and/or disclosed in the specification. Although each dependent claim listed below may directly depend on only one claim, the disclosure of various implementations includes each dependent claim in combination with every other claim in the claim set. As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiple of the same item.

No element, act, or instruction used herein should be construed as critical or essential unless explicitly described as such. Also, as used herein, the articles “a” and “an” are intended to include one or more items, and may be used interchangeably with “one or more.” Further, as used herein, the article “the” is intended to include one or more items referenced in connection with the article “the” and may be used interchangeably with “the one or more.” Furthermore, as used herein, the term “set” is intended to include one or more items (e.g., related items, unrelated items, or a combination of related and unrelated items), and may be used interchangeably with “one or more.” Where only one item is intended, the phrase “only one” or similar language is used. Also, as used herein, the terms “has,” “have,” “having,” or the like are intended to be open-ended terms. Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”). Further, spatially relative terms, such as “below,” “lower,” “above,” “upper,” “left,” “right,” and the like, may be used herein for ease of description to describe one element or feature's relationship to another element(s) or feature(s) as illustrated in the figures. The spatially relative terms are intended to encompass different orientations of the apparatus, device, and/or element in use or operation in addition to the orientation depicted in the figures. The apparatus may be otherwise oriented (rotated 90 degrees or at other orientations) and the spatially relative descriptors used herein may likewise be interpreted accordingly.

What is claimed is:

1. A fiber laser system, comprising:
a first optical fiber that includes a first core with a first diameter; and
a second optical fiber that includes a second core with a second diameter that is greater than the first diameter, wherein:
an end of the first optical fiber is connected to an end of the second optical fiber at a splice point,
a center axis of the first core is not aligned with a center axis of the second core at the splice point, and
an offset distance at the splice point between the center axis of the first core and the center axis of the second core is greater than 2 micrometers.

2. The fiber laser system of claim 1, wherein:
the first core is a single-mode core or a reduced-mode core; and
the second core is a multi-mode core.

3. The fiber laser system of claim 1, wherein:
the fiber laser system is a master oscillator power amplifier (MOPA) system;
the first optical fiber is an oscillator optical fiber; and
the second optical fiber is an amplifier optical fiber.

4. The fiber laser system of claim 1, wherein the fiber laser system is configured to allow laser light to propagate from the first optical fiber to the second optical fiber at the splice point.

5. The fiber laser system of claim 1, wherein:
an entirety of a cross-sectional area of the first core contacts a portion of a cross-sectional area of the second core at the splice point.

6. The fiber laser system of claim 5, wherein:
the portion of the cross-sectional area of the second core does not include a point associated with the center axis of the second core.

7. The fiber laser system of claim 5, wherein:
the portion of the cross-sectional area of the second core includes a point associated with the center axis of the second core.

8. The fiber laser system of claim 1, wherein:
a stimulated Raman scattering (SRS) content of an output of the fiber laser system is less than or equal to 1%.

9. A fiber laser system, comprising:
a first optical fiber that includes a first core with a first diameter; and
a second optical fiber that includes a second core with a second diameter, wherein:
an end of the first optical fiber is connected to an end of the second optical fiber at a splice point, and
an offset distance at the splice point between a center axis of the first core and a center axis of the second core is greater than 2 micrometers.

10. The fiber laser system of claim 9, wherein:
the second diameter is greater than the first diameter at the splice point.

11. The fiber laser system of claim 9, wherein:
the second diameter is greater than or equal to three times the first diameter at the splice point.

12. The fiber laser system of claim 9, wherein:
the first core is a single-mode core or a reduced-mode core; and
the second core is a multi-mode core.

13. The fiber laser system of claim 9, wherein the fiber laser system is configured to allow laser light to propagate from the first optical fiber to the second optical fiber.

14. The fiber laser system of claim 9, wherein:
the fiber laser system is configured to enable kilowatt-class material processing.

15. The fiber laser system of claim 9, wherein:
an entirety of a cross-sectional area of the first core contacts, at the splice point, a portion of a cross-sectional area of the second core that does not include a point associated with the center axis of the second core.

16. The fiber laser system of claim 9, wherein:
an entirety of a cross-sectional area of the first core contacts, at the splice point, a portion of a cross-sectional area of the second core that includes a point associated with the center axis of the second core.

17. A fiber laser system, comprising:
a first optical fiber; and
a second optical fiber, wherein:
an end of the first optical fiber is connected to an end of the second optical fiber at a splice point, and
an offset distance at the splice point between a first core of the first optical fiber and a second core of the second optical fiber allows a stimulated Raman scattering (SRS) content of an output of the fiber laser system to less than or equal to 1%.

18. The fiber laser system of claim 17, wherein:
an entirety of a cross-sectional area of the first core contacts, at the splice point, a portion of a cross-sectional area of the second core that does not include a point associated with a center axis of the second core.

19. The fiber laser system of claim 17, wherein:
an entirety of a cross-sectional area of the first core contacts, at the splice point, a portion of a cross-sectional area of the second core that includes a point associated with a center axis of the second core.

20. The fiber laser system of claim 9, wherein:
a diameter of the second core is greater than a diameter of the first core at the splice point.
